(19) United States
(12) Patent Application Publication
(10) Pub. No.: US 2020/0029572 A1
(43) Pub. Date: Jan. 30, 2020

(54) Composition and method for scent lure composition and dispersal

(71) Applicant: Robert M. Wyne, Ocean City, MD (US)

(72) Inventor: Robert M. Wyne, Ocean City, MD (US)

(21) Appl. No.: 16/048,329

(22) Filed: Jul. 29, 2018

(51) Int. Cl. A01N 63/02; A01N 25/10

(52) U.S. Cl. CPC A01N 63/02; A01N 25/10

(57) ABSTRACT

This invention relates to a composition and a method for scent dispersal. More specifically, this invention describes a scent lure method which can be rapidly and conveniently deployed without potential contamination by a hunter's individual scent.

### REFERENCES CITED

| | | |
|---|---|---|
| 5,429,271 | July 1995 | Porter |
| 5,916,552 | June 1999 | Perry |
| 8,074,640 | December 2011 | Davies et al |
| 8,387,301 | March 2013 | Williams, Sr |
| 8,490,889 | July 2013 | Rydbom |
| 8,623,346 | January 2014 | Kuhn et al |
| 8,888,550 | November 2014 | Conner |
| 9,185,904 | November 2015 | Kuhn et al |
| 9,491,940 | November 2016 | LaRosa |
| 9,565,855 | February 2017 | Kuhn et al |

### FIELD OF THE INVENTION

This invention relates to a composition and method for effectively attracting game animals while minimizing or eliminating unwanted scent contamination by a hunter.

### BACKGROUND OF THE INVENTION

When participating in hunting and other related activities, it is desirable to increase one's odds of achieving success by the acquisition of the targeted game. Due to the keen abilities of game animals to see, hear and smell hunters long before they are detected, the use of scent attractants as ‘lures’ to attract animals such as deer is often advantageous. Current methods for scent dispersal involve application of the scent to felt wicks, cotton strips, scent bubbler followed by placement of these scent dispensers at the target locations.

Particularly in the game animal mating season, male deer will often seek out female deer scents to track and locate a mating partner. However, the presence of human scents in the proximity of targeted deer scents can be detected by deer and may result in their flight from the human-scent contaminated area. Therefore there is a need in the art to develop a scent composition and dispersal system which accomplishes three critical objectives; a composition which permits the slow and steady release of scent, does not involve heating or chemical modification of the scent substance which could result in the scent molecules being compromised, and permits the delivery of that composition without contaminating the area where the scent is placed.

### SUMMARY OF THE INVENTION

The present invention provides a scent infused microporous sphere comprised of a biodegradable polymer infused with natural or synthetic liquid scent. This can include animal urine, aqueous extracts or secretions from scent glands of a game animal, other significant scent producing compounds of natural origin, or synthetically formulated chemical compounds used to attract game animals. In a preferred embodiment, the polymer is synthesized from acrylamide monomers such as methacrylamide, bis-acrylamide or acrylamide. Careful selection of the ratio of monomers in the polymerization process creates the reptacean microporous channels into which the aqueous scent solution is absorbed and dispersed through capillary action. Once the scent molecules are absorbed, exposure to open air permits their free diffusion.

The scent-filled polymer spheres are mechanically robust enough to withstand being propelled by a variety of manual as well as automated means. Dispersal of these scent-filled polymer spheres can be accomplished by a hunter from his hunting location/position by simply throwing/lobbing the spheres in the direction the scent needs to be deployed, such as targeted shooting points, strategic open areas in the line of sight of a hunter, etc. To one who is skilled in the art, it will be obvious that the current invention allows for highly efficient scent absorption and dispersal into a mechanically robust porous sphere followed by its physical deployment into a target area without the need for a hunter to contaminate the target area with human scent. To one who is skilled in the art, it will be obvious that the present invention accomplishes all three critical objectives; various changes in form and details may be made without departing from the scope of the invention.

What is claimed is:

1. A scent composition and method of dispersal comprising:
a. A naturally occurring or artificially synthesized wild game attractant in liquid form; and
b. An absorbent polymer composition to include at least one monomer such as methacrylamide, bis-acrylamide, an acrylate, or acrylamide.

2. The composition according to claim 1, wherein the naturally occurring attractant is urine from a female or male deer.

3. The composition according to claim 1, wherein the naturally occurring attractant is an extract of a tarsal gland from a male or female animal.

4. The composition according to claim 1, wherein the naturally occurring attractant is an edible food attractant selected from clover, honey, corn and apples.

5. The composition according to claim 1, wherein the naturally occurring attractant is obtained from domesticated animals including deer and goats.

6. A method of dispersing scent to attract deer comprising;
a. Assembly of a scent composition comprising (i) an acrylamide polymer particle, preferably spherical, (ii) a quantity of naturally occurring scent in liquid form such as female or male deer urine, and (iii) adding this to the aforementioned acrylamide polymer particle, wherein the quantity of deer urine absorbed into the acrylamide particle provides saturation of the particle, generally one to ten times the volume of the particle per volume of the scent liquid, herein referred to as a charged deer attractant.
b. Dispersing the charged deer attractant composition at a location to allow the scent of the attractant to attract deer to the aforementioned location.

7. The method of claim 6, wherein the scent is synthetically formulated and absorbed into the acrylamide polymer particle to provide saturation of the particle.
